(19) United States
(12) Patent Application Publication
(10) Pub. No.: US 2001/0048539 A1
(43) Pub. Date: Dec. 6, 2001

(54) Optical transmission system

(75) Inventors: Yuji Kubo, Yokohama-shi (JP); Yoshiaki Terasawa, Yokohama-shi (JP)

Correspondence Address: MCDERMOTT WILL & EMERY, 600 13TH STREET, N.W., WASHINGTON, DC, 20005-3096, US

(73) Assignee: Sumitomo Electric Industries, Inc.

(21) Appl. No.: 09/870,793

(22) Filed: Jun. 1, 2001

(30) Foreign Application Priority Data
Jun. 1, 2000 (JP) P2000-164929

(51) Int. Cl. H04B 10/00; H04B 10/12

(52) U.S. Cl. 359/161; 359/173

(57) ABSTRACT

The invention relates to an optical transmission system having the structure of effectively suppressing variation in cumulative chromatic dispersion in an optical fiber transmission line from a transmitter to a receiver, thereby enabling large-capacity phototransmission. The optical transmission system according to the invention monitors variation of chromatic dispersion in the optical fiber transmission line and compensates for the variation of chromatic dispersion, thereby suppressing the variation of cumulative chromatic dispersion on the whole of the optical fiber transmission line. The variation of chromatic dispersion is calculated by monitoring temperature variation of the optical fiber transmission line or by letting monitor light propagate in a dummy fiber transmission line disposed in parallel to the optical fiber transmission line. On the other hand, the compensation for the variation of chromatic dispersion is implemented by shifting the wavelength of the signal from the transmitter to the longer wavelength side or to the shorter wavelength side or by use of a dispersion compensator such as a dispersion compensating optical fiber or the like.

### BACKGROUND OF THE INVENTION

1. Field of the Invention

The present invention relates to an optical transmission system for transmitting a signal from a transmitter through an optical fiber transmission line to a receiver.

2. Related Background Art

An optical transmission system is provided with an optical fiber transmission line placed between a transmitter and a receiver and transmits a signal from the transmitter to the receiver. This optical transmission system enables long-haul transmission of large capacity of information. Optical transmission systems of this type include wavelength division multiplexing (WDM) transmission systems for transmitting signals of multiple channels of mutually different wavelengths (in the form of multiplexed signal), which enable transmission of larger capacity of information. Concerning the optical transmission systems as described above, there are needs for further increase in capacity; specifically, there are attempts to expand a signal wavelength band and increase the number of signal channels and to increase bit rates of signals to higher rates.

In the optical transmission systems, there can occur reception errors due to degradation of signal waveform caused by chromatic dispersion in the optical fiber transmission line. In the optical transmission systems it is thus important to keep small the absolute value of cumulative chromatic dispersion in the line from the transmitter to the receiver. Research and development is under way to provide a dispersion flattened fiber the absolute value of chromatic dispersion of which is small across the entire signal wavelength band, but the present status is that there are a lot of constraints on manufacturing and manufacturing cost is high. In general it is difficult to make small the absolute value of chromatic dispersion across the entire signal wavelength band by use of only one type of optical fiber. It is thus common practice to employ a technique of disposing a dispersion compensator, in addition to the fiber transmission line, between the transmitter and the receiver to compensate for the chromatic dispersion (and a dispersion slope) of the fiber transmission line and thereby maintaining the absolute value of cumulative chromatic dispersion in the line from the transmitter to the receiver, small across the entire signal wavelength band.

### SUMMARY OF THE INVENTION

The inventors studied the prior arts and found the following problem. Namely, the fiber transmission lines are often laid outdoors and are readily affected by external factors such as variation in ambient temperature in general. With occurrence of temperature variation, the chromatic dispersion also varies in the fiber transmission line, so that the cumulative chromatic dispersion also varies in the entire transmission system incorporating the fiber transmission line and the dispersion compensator. For the conventional optical transmission systems, it is sufficient to control the variation of chromatic dispersion in the fiber transmission line due to the external factors such as the temperature variation to within design tolerance, but, in order to meet the recent needs for large-capacity information transmission, it is inevitable to narrow the tolerance of variation of cumulative chromatic dispersion in the line from the transmitter to the receiver. Even with occurrence of the variation in the external environment, such as the temperature, the variation in the absolute value of cumulative chromatic dispersion on the whole of the transmission system must be precisely managed so as to be maintained within tolerance. It is, however, not practical to control the variation of the external environment itself, such as the temperature of the fiber transmission line or the like, in order to suppress the variation of chromatic dispersion in the fiber transmission lines commonly laid outdoors.

The present invention has been accomplished in order to solve the above problem and an object of the invention is to provide an optical transmission system having such structure that even if the chromatic dispersion in the fiber transmission line varies because of the external factors the variation of cumulative chromatic dispersion is effectively suppressed in the line from the transmitter to the receiver and it is feasible to further increase the capacity in information transmission.

Optical transmission systems according to the present invention include WDM transmission systems for transmitting the multiplexed signal of channels of mutually different wavelengths. An optical transmission system according to the present invention comprises an optical fiber transmission line disposed between a transmitter and a receiver, a dispersion compensating system for compensating for chromatic dispersion in the optical fiber transmission line, a measuring system for monitoring variation in temperature of the optical fiber transmission line or variation of chromatic dispersion in the optical fiber transmission line, and a control system for controlling a dispersion compensation amount of the dispersion compensating system, based on the result of measurement by the measuring system. In the optical fiber transmission line a signal from the transmitter (including the multiplexed signal of mutually different wavelengths) propagates toward the receiver.

As constructed in the above structure, even if there occurs change in the external environment, such as the temperature variation, in the optical fiber transmission line, the variation of cumulative chromatic dispersion will be effectively suppressed in the optical fiber transmission line from the transmitter to the receiver (or the variation of cumulative chromatic dispersion due to the temperature variation or the like will be maintained within tolerance); therefore, the optical transmission system of the invention enables optical transmission of larger capacity than the conventional optical transmission systems.

In the optical transmission system according to the present invention, the foregoing measuring system is comprised of at least either of a configuration for monitoring change of the external environment being a factor to vary the chromatic dispersion in the optical fiber transmission line and a configuration for monitoring the variation of chromatic dispersion itself in the optical fiber transmission line.

In the case where the measuring system monitors the change of the external environment, e.g., temperature, the measuring system preferably includes a temperature sensor for detecting the temperature of the optical fiber transmission line. Preferably, the temperature sensor is, for example, an optical fiber temperature sensor of the Rayleigh scattering type, the Raman scattering type, the Brillouin scattering type, or the like (which is disposed along the optical fiber transmission line). In this case, where the temperature sensor is the optical fiber temperature sensor, the sensor detects a temperature distribution in the longitudinal direction of the optical fiber transmission line. The optical fiber transmission line is applied to one transmission line in an optical cable in which a plurality of optical fibers are bundled. The optical fiber temperature sensor is more preferable, because it, together with the optical fiber transmission line, can be housed in the optical cable. The temperature sensor may monitor the temperature at a splice portion of the optical cable or the temperature in a repeater including an optical amplifier and others. Since the optical cable includes a tension member of metal extending along the optical fiber transmission line, the sensor may be of a configuration of monitoring the temperature variation by monitoring variation in metal resistance of the tension member. In either case, the control system calculates the variation of chromatic dispersion due to the temperature variation of the optical fiber transmission line, based on the temperature of the optical fiber transmission line detected by the temperature sensor, and controls the dispersion compensating system so that the dispersion compensation amount of the dispersion compensating system becomes an appropriate value.

On the other hand, in the case where the foregoing measuring system is one for monitoring the variation of chromatic dispersion itself in the optical fiber transmission line, the measuring system preferably includes a dummy fiber transmission line disposed along the optical fiber transmission line, a light source for emitting monitor light of a predetermined wavelength into the dummy fiber transmission line, and a photodetector for receiving the monitor light having propagated through the dummy fiber transmission line. In this case, the control system calculates an amount of variation of chromatic dispersion in the optical fiber transmission line, based on the result of detection of light quantity by the photodetector, and controls the dispersion compensating system so that the dispersion compensation amount of the dispersion compensating system becomes an appropriate value.

In the optical transmission system according to the present invention, the dispersion compensation by the dispersion compensating system is implemented by a configuration making use of a dispersion compensator such as a dispersion compensating optical fiber or a fiber grating, or by a configuration of adjusting the wavelength of the signal sent out of the transmitter (or adjusting the wavelength of each signal channel in the case of the multiplexed signal). In the structure where the dispersion compensating system includes the dispersion compensator, a plurality of dispersion compensators can be installed on the signal propagating path and it becomes feasible to implement fine adjustment of dispersion amount on the whole of the optical transmission system, by individually adjusting dispersion compensation amounts of those dispersion compensators.

On the other hand, in the case where the dispersion compensation by the dispersion compensating system is implemented by adjusting the wavelength of the signal sent out of the transmitter, in every signal channel, the control system calculates an average change amount of chromatic dispersion on the whole of the optical fiber transmission line and controls light sources so that the wavelengths of signals emitted from the respective light sources in the transmitter are shifted by a predetermined amount to the longer wavelength side or to the shorter wavelength side according to the change amount obtained.

In either of these dispersion compensations, the variation of cumulative chromatic dispersion will be effectively suppressed in the line from the transmitter to the receiver even if there occurs change of the external environment such as the temperature variation of the optical fiber transmission line.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a drawing showing a configuration of a first embodiment of the optical transmission system according to the present invention;

FIG. 2 is a view showing a cross-sectional structure of an optical cable (including optical fiber transmission lines and an optical fiber temperature sensor) to which the optical fiber transmission line constituting part of the optical transmission system according to the first embodiment is applied;

FIG. 3 is a graph for explaining an example of dispersion compensation (compensation for chromatic dispersion due to temperature variation) by the control system in the optical transmission system according to the present invention;

FIG. 4 is a graph for explaining another example of dispersion compensation (compensation for chromatic dispersion due to temperature variation) by the control system in the optical transmission system according to the present invention; and

FIG. 5 is a drawing showing a configuration of a second embodiment of the optical transmission system according to the present invention.

### DESCRIPTION OF THE PREFERRED EMBODIMENTS

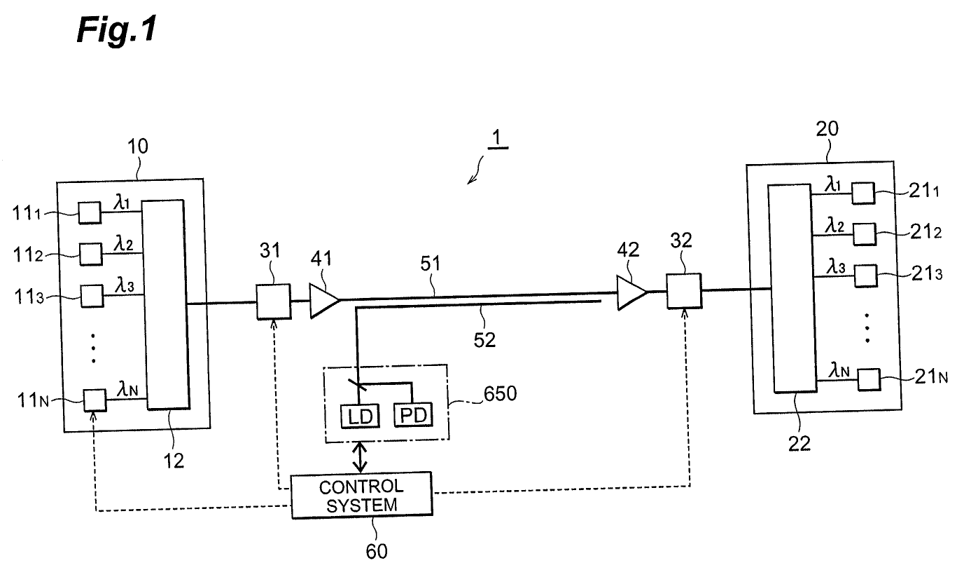

Each of embodiments of the optical transmission system according to the present invention will be described below in detail with reference to FIGS. 1 to 5. In the description of the drawings the same elements will be denoted by the same reference symbols and redundant description will be omitted.

FIG. 1 is a drawing showing the configuration of the first embodiment of the optical transmission system according to the present invention. In this optical transmission system according to the first embodiment, the dispersion compensation is implemented by making use of temperature dependence of chromatic dispersion. For example, the technology described in U.S. patent application Ser. No. 09/771937 is one of technologies for detecting the variation of chromatic dispersion by measurement of temperature, and the first embodiment employs the optical fiber temperature sensor as the temperature sensor from the viewpoint of enabling highly accurate control of chromatic dispersion and enabling compactification of apparatus itself.

The optical transmission system 1 according to the first embodiment transmits the multiplexed signal of wavelengths λ₁ to λ_{N} from transmitter 10 through optical fiber transmission line 51 to receiver 20. The optical transmission system 1 has the transmitter 10 and the receiver 20, and also includes a dispersion compensator 31, an optical amplifier 41, the optical fiber transmission line 51, an optical amplifier 42, and a dispersion compensator 32, which are arranged in the order named from the transmitter 10 to the receiver 20. This optical transmission system 1 is further provided with optical fiber temperature sensor 52 and control system 60.

The dispersion compensator 31 and optical amplifier 41 may be disposed together with the transmitter 10 in a transmitting station, or may be disposed in a repeater station. The dispersion compensator 32 and optical amplifier 42 may be disposed together with the receiver 20 in a receiving station, or may be disposed in a repeater station. The optical fiber transmission line 51, optical amplifier 42, and dispersion compensator 32 may be of a single-stage configuration as illustrated, or of a multistage configuration.

The transmitter 10 includes N light sources 11₁ to 11_{N} and a multiplexer 12. Signals of wavelengths λ₁ to λ_{N} emitted from the respective light sources 11₁ to 11_{N} are multiplexed by the multiplexer 12 and the multiplexed signal is sent from the multiplexer 12 through the dispersion compensator 31 and optical amplifier 41 into the optical fiber transmission line 51. On the other hand, the receiver 20 includes N photoreceptive devices (photodetectors) 21₁ to 21_{N} and a demultiplexer 22. The multiplexed signal arriving at the receiver 20 is demultiplexed once into signals of wavelengths λ₁ to λ_{N} by the demultiplexer 22 and the signals thus demultiplexed are then received by the respective photoreceptive devices 21₁ to 21_{N} provided corresponding to the respective signals. The signals of the wavelengths λ₁ to λ_{N} are, for example, those in the 1.55-μm wavelength band.

The optical fiber transmission line 51 is a transmission medium for transmitting the multiplexed signal from the transmitter 10 to the receiver 20, and is normally laid outdoors. An optical fiber suitable for construction of the optical fiber transmission line 51 is, for example, a single-mode optical fiber having the zero dispersion wavelength near the wavelength of 1.3 μm and the chromatic dispersion of about 17 ps/nm/km at the wavelength of 1.55 μm, or a non-zero dispersion-shifted optical fiber having the zero dispersion wavelength present in a range except for the vicinity of the wavelength of 1.55 μm and the chromatic dispersion of 1 to 10 ps/nm/km at the wavelength of 1.55 μm.

The dispersion compensators 31, 32 compensate for the chromatic dispersion of the optical fiber transmission line 51 and the dispersion slope of the optical fiber transmission line 51 at a predetermined temperature T in the signal wavelength band including the wavelengths λ₁ to λ_{N}. The dispersion compensators 31, 32 are suitably selected, for example, from dispersion compensating optical fibers having negative chromatic dispersion at the wavelength of 1.55 μm, dispersion compensating optical fibers having a negative dispersion slope at the wavelength of 1.55 μm, or optical fiber gratings with index modulation in an optical waveguide region. These dispersion compensators 31, 32 are included in the dispersion compensating system.

The optical amplifiers 41, 42 are optical devices for amplifying the multiplexed signal from the transmitter 10 en bloc, and suitable optical amplifiers are Er-doped optical fiber amplifiers (EDFA: Erbium-Doped Fiber Amplifiers) in which an Er-doped optical fiber (EDF: Erbium-Doped Fiber) with an optical waveguide region doped with element Er is applied as an optical amplification medium.

The optical fiber temperature sensor 52 is disposed in parallel to the optical fiber transmission line 51 and can be selected, for example, from the known optical fiber temperature sensors of the Rayleigh scattering type, the Raman scattering type, the Brillouin scattering type, and so on. The temperature detection by measuring system 650 is one utilizing the temperature dependence of optical fiber characteristics, and the measuring system 650 has a light source LD for emitting pulsed light from the control system 60 toward one end of the optical fiber temperature sensor 52, and a photodetector PD for detecting backscattered light generated in the optical fiber temperature sensor 52 and reaching the one end. The control system 60 monitors temporal change from the time of output of the pulsed light to the arrival of the backscattered light and (based on the result of measurement by the measuring system 650) thereby detects a temperature distribution in the longitudinal direction of the optical fiber temperature sensor 52, i.e., a temperature distribution in the longitudinal direction of the optical fiber transmission line 51. Further, the control system 60 controls a dispersion compensating operation so as to compensate for the chromatic dispersion of the optical fiber transmission line 51, based on the result of detection of the temperature distribution of the optical fiber transmission line 51. As a result of this dispersion compensation, the variation of cumulative chromatic dispersion is suppressed in the line from the transmitter 10 to the receiver 20 even with temperature variation of the optical fiber transmission line 51. This dispersion compensation can be implemented as follows; the control system 60 controls the light sources 11₁ to 11_{N} so as to shift the wavelengths of the signals emitted from the respective light sources 11₁ to 11_{N} of the transmitter 10 to the longer wavelength side or to the shorter wavelength side. In this case, the dispersion compensating system is composed of the control system 60 and the light sources 11₁ to 11_{N}. The dispersion compensation can also be implemented so that the control system 60 controls a dispersion compensation amount in the dispersion compensator 31 and/or the dispersion compensator 32. In this case, the dispersion compensating system is composed of the control system 60 and the dispersion compensators 31, 32.

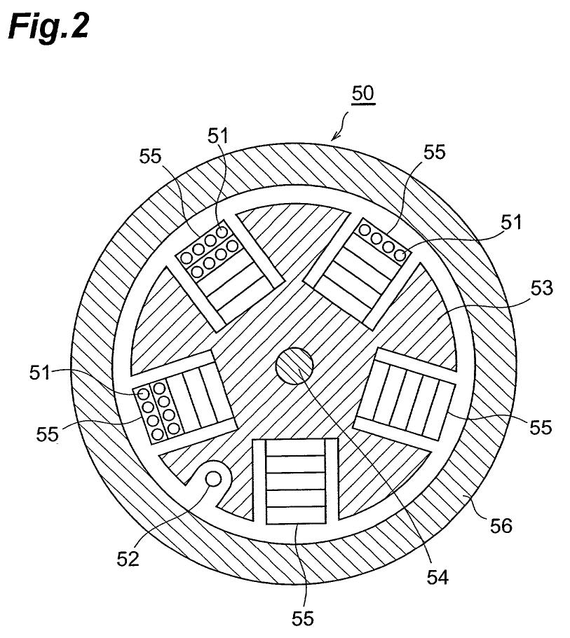

FIG. 2 is a view showing the cross-sectional structure of optical cable 50 including the above-mentioned optical fiber transmission lines 51 and the optical fiber temperature sensor 52. The optical cable 50 has a slotted rod 53 provided with a tension member 54 of metal in the center. Six slots are provided along the longitudinal direction in the outer periphery surface of the slotted rod 53. The optical fiber temperature sensor 52 is set in one of the six slots and a plurality of ribbon fibers 55 (each of which includes a plurality of optical fibers placed on a flat basis as optical fiber transmission lines 51) are housed in a stacked state in each of the five rest slots. An envelope 56 covers the periphery of the slotted rod 53 in which the optical fiber transmission lines 51 and the optical fiber temperature sensor 52 are set in the respective slots as described above. The optical fibers in each ribbon fiber 55 correspond to the optical fiber transmission lines 51, respectively.

In the optical transmission system 1 according to the first embodiment, the transmitter 10 emits the multiplexed signal of the wavelengths λ₁ to λ_{N} (resulting from multiplexing of the signals emitted from the light sources 11₁ to 11_{N}, in the multiplexer 12) and the multiplexed signal travels successively through the dispersion compensator 31, optical amplifier 41, optical fiber transmission line 51, optical amplifier 42, and dispersion compensator 32 to reach the receiver 20. The multiplexed signal reaching the receiver 20 is demultiplexed in every wavelength (every signal channel) by the demultiplexer 22 and the signals of the respective wavelengths are received by the corresponding photodetectors 21₁ to 21_{N}. The cumulative chromatic dispersion during the traveling period of the multiplexed signal from the transmitter 10 to the receiver 20 is the cumulative sum of chromatic dispersions in all the elements on the transmission path of the multiplexed signal and, particularly, the optical fiber transmission line 51 and dispersion compensators 31, 32 make great contribution to the chromatic dispersion. Since the chromatic dispersions of the respective dispersion compensators 31, 32 are set so as to compensate for the chromatic dispersion of the optical fiber transmission line 51 at the given temperature T, the absolute value of cumulative chromatic dispersion in the line from the transmitter 10 to the receiver 20 is kept small at this temperature T. When the temperature of the optical fiber transmission line 51 varies from T to T+ΔT, the temperature variation ΔT is detected by the optical fiber temperature sensor 52, measuring system 650, and control system 60. Then the control system 60 executes the dispersion compensation control so as to suppress the variation in the chromatic dispersion of the optical fiber transmission line 51, based on the result of the temperature detection of the optical fiber transmission line 51.

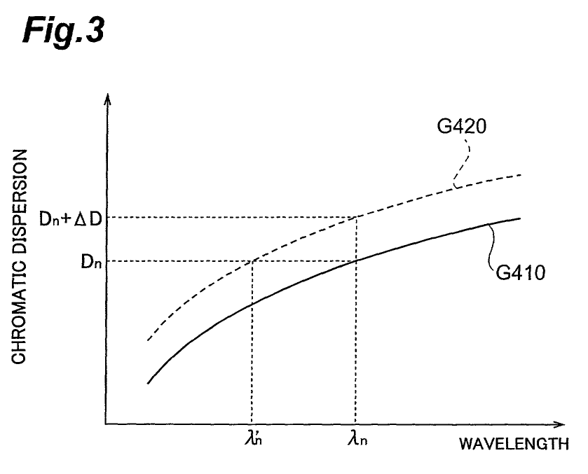

FIG. 3 is a graph for explaining an example of the dispersion compensation by the control system 60, i.e., a case of compensating for the variation in chromatic dispersion due to the temperature variation of the optical fiber transmission line 51, by controlling the wavelength of the signal from each light source 11ₙ (1≦n≦N) in the transmitter 10. In FIG. 3 a curve G410 indicates a chromatic dispersion property of the optical fiber transmission line 51 at the temperature T and a curve G420 that of the optical fiber transmission line 51 at the temperature T+ΔT.

We assume here that the output wavelength λₙ of the light source 11ₙ in the transmitter 10 is kept constant. When the temperature T varies by ΔT to the temperature T+ΔT, the chromatic dispersion Dₙ at the temperature T changes to Dₙ+ΔD. As a result, the cumulative chromatic dispersion varies in the line from the transmitter 10 to the receiver 20. Detecting the variation of ΔT in the temperature of the optical fiber transmission line 51 through the temperature measurement by the measuring system 650 using the optical fiber temperature sensor 52, the control system 62 then controls the temperature, driving current, etc. of the light source 11ₙ in the transmitter 10 to change the wavelength of the signal emitted from the light source 11ₙ, to λₙ′ (to make use of the wavelength dependence of dispersion). This compensates for the variation of chromatic dispersion of the optical fiber transmission line 51.

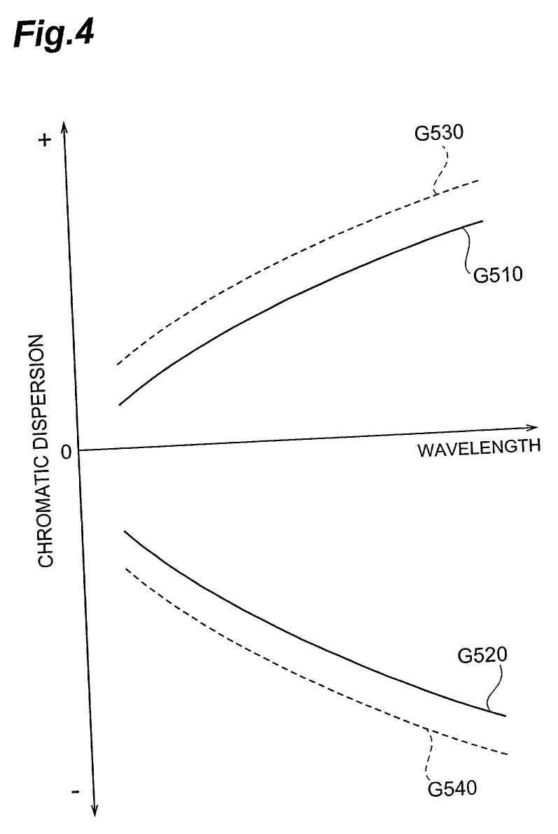

FIG. 4 is a graph for explaining another example of the dispersion compensation by the control system 60, i.e., a case of compensating for the variation of chromatic dispersion due to the temperature variation of the optical fiber transmission line 51, by controlling a dispersion compensation amount in the dispersion compensating optical fibers as dispersion compensators 31, 32. In FIG. 4 a curve G510 represents a chromatic dispersion property of the optical fiber transmission line 51 at the temperature T₁, a curve G530 that at the temperature T₁+ΔT₁, a curve G520 a chromatic dispersion property of each dispersion compensator 31, 32 at the temperature T₂, and a curve G540 that at the temperature T₂+ΔT₂.

Let us suppose that when the temperature of the optical fiber transmission line 51 is T₁ and the temperature of the dispersion compensators 31, 32 is T₂, the absolute value of cumulative chromatic dispersion is sufficiently small in the line from the transmitter 10 to the receiver 20. If the temperature of the optical fiber transmission line 51 varies by ΔT₁ to the temperature T₁+66 T₁ under such circumstances, the cumulative chromatic dispersion varies in the line from the transmitter 10 to the receiver 20. Then the control system 60 detects the variation of ΔT₁ in the temperature of the optical fiber transmission line 51 through the temperature measurement by the measuring system using the optical fiber temperature sensor 52. Then the control system 60 changes the temperature of the dispersion compensators 31, 32 by ΔT₂ to control the dispersion compensation amount, thereby compensating for the variation of chromatic dispersion of the optical fiber transmission line 51.

When optical fiber gratings are used as the dispersion compensators 31, 32, their dispersion compensation amount is controlled by changing the temperature of the optical fiber gratings or tension exerted thereon, thereby compensating for the variation of chromatic dispersion of the optical fiber transmission line 51.

The present invention is by no means intended to be limited to the above embodiments, but can be subject to a variety of modifications. For example, the measuring system for measuring the temperature of the fiber transmission line 51 is preferably one for detecting the temperature by use of the optical fiber temperature sensor 52 as described above, but is not limited to this.

For example, since the tension member 4 in the optical cable 50 is usually a metal material, an average temperature in the longitudinal direction of the optical fiber transmission line 51 can be detected by measuring the conductor resistance of this tension member 54 by the measuring system. When the tension member 54 is one plated with a metal of low resistance, e.g., copper on the surface, it becomes feasible to detect the temperature with high accuracy over a long distance.

Since the temperature distribution in the longitudinal direction of the optical fiber transmission line 51 exhibits only a small temperature difference over a distance of about several ten km, the temperature does not have to be detected at small intervals of distance. For example, the temperature may be detected at a splice portion or at a repeater of the optical cable 50. The information about the result of this temperature detection is sent as a control signal through an optical fiber in the optical cable 50 to the control system 60.

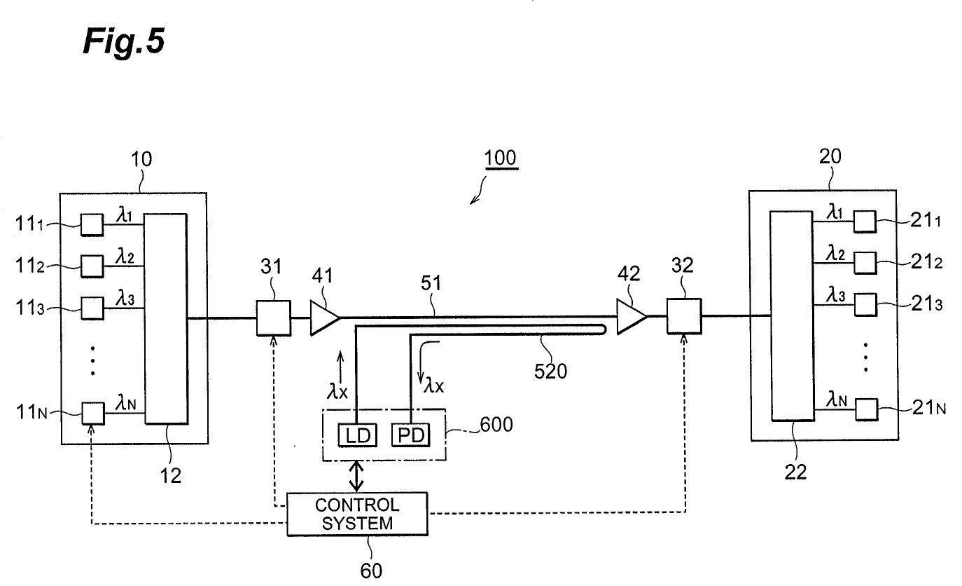

As described above, the optical transmission system 1 according to the first embodiment has the configuration of effectively suppressing the variation of cumulative chromatic dispersion in the line from the transmitter 10 to the receiver 20 by making use of the temperature change of the optical fiber transmission line 51, but the dispersion compensation may also be implemented by directly measuring the variation of cumulative chromatic dispersion, as in the optical transmission system 100 according to the second embodiment described below. FIG. 5 is a view showing the configuration of the second embodiment of the optical transmission system according to the present invention. The optical transmission system 100 according to the second embodiment has the same structure as the structure of the optical transmission system 1 according to the first embodiment, except for the structure for measuring the cumulative chromatic dispersion.

Namely, the optical transmission system 100 according to the second embodiment is provided with a dummy fiber transmission line 520 of a closed loop in which monitor light of a wavelength λ_{X} propagates and which is disposed along the optical fiber transmission line 51. The dummy fiber transmission line 520 may be an open loop transmission line one end of which is processed so as to totally reflect light (structure similar to the optical fiber temperature sensor 52 in FIG. 1).

The measuring system 600 is provided with a light source LD for emitting the monitor light of the wavelength λ_{X} into the dummy fiber transmission line 520 and a photodetector PD for receiving the monitor light having propagated through the dummy fiber transmission line 520. Since the optical fiber transmission line 51 and the dummy fiber transmission line 520 constitute the optical cable of the structure as shown in FIG. 2, the optical fiber transmission line 51 and dummy fiber transmission line 520 are set under the same environment. Accordingly, by monitoring the variation of cumulative chromatic dispersion of the dummy fiber transmission line 520 (and letting the control system 60 calculate a variation amount of chromatic dispersion, based on the result of measurement by the measuring system 600), it becomes feasible to analogize the variation of cumulative chromatic dispersion in the optical fiber transmission line 51 with high accuracy.

In the second embodiment, the compensation for the cumulative chromatic dispersion in the optical fiber transmission line 51 is implemented by controlling each of the wavelengths of the signals emitted from the respective light sources 11₁ to 11_{N} included in the transmitter 10, or by controlling the dispersion compensation amount of the dispersion compensators 31, 32 such as the dispersion compensating optical fibers, the optical fiber gratings, or the like. In the case of the dispersion compensation by the control of wavelengths of output signals, the light sources 11₁ to 11_{N} and control system 60 constitute the dispersion compensating system. In the case of the dispersion compensation by the dispersion compensators 31, 32, these dispersion compensators 31, 32 and the control system 60 constitute the dispersion compensating system.

As described above, the optical transmission systems according to the present invention have the structure of directly or indirectly detecting the variation amount of cumulative chromatic dispersion of the optical fiber transmission line for transmitting the signal from the transmitter to the receiver and the structure of suppressing the variation of chromatic dispersion in the optical fiber transmission line, based on the result of the detection. By provision of these structures, the variation of cumulative chromatic dispersion will be effectively suppressed in the line from the transmitter to the receiver even if the variation of chromatic dispersion due to the change of the external environment such as the temperature in the optical fiber transmission line occurs in part or in whole of the optical fiber transmission line. As a result, the variation of cumulative chromatic dispersion in the fiber transmission line due to the external factors is maintained within tolerance, thereby enabling larger-capacity phototransmission.

When the optical fiber temperature sensor is used for the detection of variation of chromatic dispersion, the temperature distribution in the longitudinal direction of the optical fiber transmission line is detected with accuracy. When the dummy fiber transmission line is used, the variation of chromatic dispersion in the fiber transmission line is detected with accuracy. Therefore, these configurations enable stabler phototransmission. The configurations both are preferable, because the optical fiber temperature sensor or the dummy fiber transmission line can be housed together with the optical fiber transmission line in the optical cable.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical transmission system comprising:
an optical fiber transmission line disposed between a transmitter for transmitting a signal of a predetermined wavelength and a receiver for receiving the signal, through which the signal propagates from the transmitter toward the receiver;
a dispersion compensating system for compensating for chromatic dispersion in said optical fiber transmission line;
a measuring system for monitoring variation in temperature of said optical fiber transmission line or variation of chromatic dispersion in said optical fiber transmission line; and
a control system for controlling a dispersion compensation amount of said dispersion compensator, based on the result of measurement by said measuring system.

2. An optical transmission system according to claim 1, wherein said measuring system includes a temperature sensor for detecting the temperature of said optical fiber transmission line.

3. An optical transmission line according to claim 1, wherein said measuring system includes a dummy fiber transmission line disposed along said optical fiber transmission line, a light source for emitting monitor light of a predetermined wavelength into the dummy fiber transmission line, and a photodetector for receiving the monitor light having propagated through the dummy fiber transmission line, and wherein said control system calculates a variation amount of chromatic dispersion in said optical fiber transmission line, based on the result of detection of light quantity by the photodetector.

4. An optical transmission system according to claim 2, wherein said temperature sensor includes an optical fiber temperature sensor disposed along said optical fiber transmission line.

5. An optical transmission system according to claim 1, wherein said dispersion compensating system shifts the wavelength of the signal from said transmitter to the longer wavelength side or to the shorter wavelength side, thereby compensating for the variation of chromatic dispersion due to variation in temperature of said optical fiber transmission line.

6. An optical transmission system according to claim 1, wherein said dispersion compensating system includes a dispersion compensator disposed on a signal light path from said transmitter to said receiver, and wherein said control system controls the dispersion compensation amount of said dispersion compensator according to a variation amount of chromatic dispersion in said optical fiber transmission line.

7. An optical transmission system according to claim 6, wherein said dispersion compensator includes a dispersion compensating optical fiber.

8. An optical transmission system according to claim 6, wherein said dispersion compensator includes an optical fiber grating.
